(19) United States
(12) Patent Application Publication
(10) Pub. No.: US 2010/0198416 A1
(43) Pub. Date: Aug. 5, 2010

(54) REFRIGERATION SYSTEM

(75) Inventors: Shinichi Kasahara, Osaka (JP); Tetsuya Okamoto, Osaka (JP)

Correspondence Address: BIRCH STEWART KOLASCH & BIRCH, PO BOX 747, FALLS CHURCH, VA, 22040-0747, US

(73) Assignee: DAIKIN INDUSTRIES, LTD., Osaka (JP)

(21) Appl. No.: 12/667,019

(22) PCT Filed: Jun. 27, 2008
(86) PCT No.: PCT/JP2008/001689

§ 371 Date: Dec. 28, 2009

(30) Foreign Application Priority Data
Jun. 29, 2007 (JP) 2007-173438

(51) Int. Cl. G05D 7/00; F25B 41/04

(52) U.S. Cl. 700/282; 62/225

(57) ABSTRACT

A degree-of-superheat control unit (44) is configured to adjust the degree of opening of an indoor expansion valve (26) based on a control gain for determining an opening-degree adjustment amount of the indoor expansion valve (26), and includes a control-gain determination unit (41) configured to increase a control gain g when the target-degree-of-superheat determination unit (39) increases a target degree of superheat SHs and to reduce the control gain g when the target-degree-of-superheat determination unit (39) reduces the target degree of superheat SHs.

### TECHNICAL FIELD

The present disclosure relates to techniques for controlling expansion valves provided in refrigeration systems.

### BACKGROUND ART

In a known conventional refrigeration system including a refrigerant circuit, a refrigeration cycle is performed by circulating refrigerant. Examples of a method for controlling operation of this refrigeration system include the technique of controlling the degree of superheat by using an electric expansion valve as shown in, for example, Patent Document 1.

In this technique of controlling the degree of superheat, the degree of opening of the electric expansion valve is adjusted such that the degree of superheat obtained from an evaporator-outlet temperature of refrigerant measured in the refrigerant circuit (hereinafter referred to as a detected degree of superheat) reaches a target the degree of superheat. In general, if the refrigerant circuit includes a plurality of evaporators, the control of degree of superheat described above is performed in order to control performance of each of the evaporators.

Specifically, a controller for controlling performance of each of the evaporators sets the target degree of superheat according to required performance of the evaporator. Then, in the control of degree of superheat, the degree of opening of each electric expansion valve is adjusted so that the detected degree of superheat of each of the evaporators reaches the target degree of superheat. More specifically, to impair the performance of the evaporator, the target degree of superheat is increased. On the other hand, to enhance the performance of the evaporator, the target degree of superheat is reduced. In this manner, the performance of the evaporator is controlled by setting the target degree of superheat.

### PATENT DOCUMENT 1: Japanese Patent Publication No. 2007-040567

### SUMMARY OF THE INVENTION

### Technical Problems

When the controller reduces the target degree of superheat, however, the evaporator-outlet temperature overshoots an outlet temperature of refrigerant associated with the target degree of superheat (hereinafter referred to as a target outlet temperature) in some cases. If the amount of this overshoot is large, the evaporator-outlet temperature excessively decreases, resulting in that refrigerant at the evaporator outlet is more likely to change from a superheated state to a wet state. When the evaporator-outlet temperature excessively decreases to cause refrigerant at the evaporator outlet to be in the wet state, the evaporator-outlet temperature becomes unstable under the influence of refrigerant droplets. Accordingly, while the refrigerant at the evaporator outlet is in the wet state, the degree of superheat cannot be effectively controlled.

In a case where the degree of opening of the electric expansion valve is adjusted such that the overshoot described above is reduced in order to solve the above problem, the degree of superheat might not be effectively controlled when the controller increases the target degree of superheat.

It is therefore an object of the present invention to enhance controllability in controlling the degree of superheat by using an expansion valve in a refrigeration system.

### Solution to the Problems

A first aspect of the present invention is directed to a refrigeration system including: a refrigerant circuit (20) in which at least one evaporator (27) and at least one expansion valve (26) associated with the evaporator (27) are connected to each other to perform a refrigeration cycle; a calculation means (40) configured to calculate a degree of superheat of refrigerant based on an evaporator-outlet temperature of refrigerant circulating in the refrigerant circuit (20); and a degree-of-superheat control means (44) configured to adjust a degree of opening of the expansion valve (26) such that the calculated degree of superheat reaches a target degree of superheat.

In the first aspect, the refrigeration system further includes a change means (39) configured to change the target degree of superheat. The degree-of-superheat control means (44) is configured to adjust the degree of opening of the expansion valve (26) based on a control gain for determining an opening-degree adjustment amount of the expansion valve (26), and includes a control gain setting means (41) configured to increase the control gain when the change means (39) increases the target degree of superheat and to reduce the control gain when the change means (39) reduces the target degree of superheat.

Here, in a case where a plurality of evaporators (27) are provided, for example, the performance of these evaporators (27) needs to be individually controlled. To achieve this control, the change means (39) changes the target degree of superheat of each of the evaporators (27) such that required performance of each of the evaporators (27) is obtained. In this manner, the target degree of superheat of the evaporator (27) having a heavy refrigeration load is reduced, whereas the target degree of superheat of the evaporator (27) having a light refrigeration load is increased.

In the first aspect, responsiveness of opening-degree adjustment of the expansion valve (26) can be changed according to a change in the target degree of superheat. Specifically, when the change means (39) reduces the target degree of superheat, the control gain setting means (41) reduces the control gain. Accordingly, the opening-degree adjustment amount of the expansion valve (26) decreases, and thus responsiveness of the detected degree of superheat to the target degree of superheat decreases. On the other hand, when the change means (39) increases the target degree of superheat, the control gain setting means (41) increases the control gain. Accordingly, the opening-degree adjustment amount of the expansion valve (26) increases, and thus responsiveness of the detected degree of superheat to the target degree of superheat increases.

In a second aspect of the present invention, in the refrigeration system of the first aspect, the control gain setting means (41) includes a calculation means configured to calculate a set value of the control gain based on a first control gain function in which a relationship between the target degree of superheat and the control gain is determined beforehand.

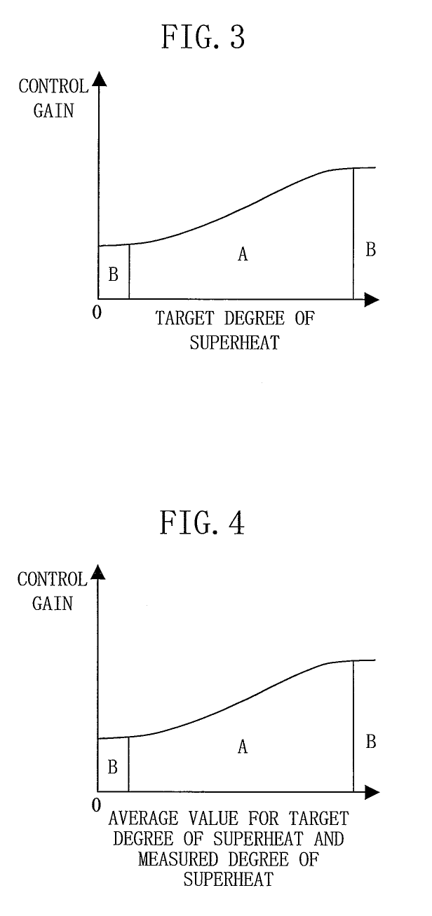

In the second aspect, an optimum set amount of the control gain can be calculated from the target degree of superheat based on the first control gain function. The first control gain function herein is a function as shown in FIG. 3, for example. The first control gain function includes a first region (A) where the control gain changes with a change in the target degree of superheat and a second region (B) where the control gain does not change with a change in the target degree of superheat. In the first region (A), the control gain decreases as the target degree of superheat decreases, and thus the opening-degree adjustment amount of the expansion valve (26) decreases, resulting in that responsiveness of the detected degree of superheat to the target degree of superheat decreases. On the other hand, the control gain increases as the target degree of superheat increases, and thus the opening-degree adjustment amount of the expansion valve (26) increases, resulting in that responsiveness of the detected degree of superheat to the target degree of superheat increases.

In a third aspect of the present invention, in the refrigeration system of the first aspect, the control gain setting means (41) includes a calculation means configured to calculate a set value of the control gain based on a second control gain function in which a relationship between the control gain and an average value for the target degree of superheat and a measured degree of superheat calculated by the calculation means (40) is determined beforehand.

In the third aspect, an optimum set amount of the control gain can be calculated from the average value based on the second control gain function. The second control gain function herein a function as shown in FIG. 4, for example. The second control gain function includes a first region (A) where the control gain changes with a change in the average value and a second region (B) where the control gain does not change with a change in the average value. In the first region (A), the control gain decreases as the average value decreases, and thus the opening-degree adjustment amount of the expansion valve (26) decreases, resulting in that responsiveness of the detected degree of superheat to the target degree of superheat decreases. On the other hand, the control gain increases as the average value increases, and thus the opening-degree adjustment amount of the expansion valve (26) increases, resulting in that responsiveness of detected degree of superheat to the target degree of superheat increases.

In a fourth aspect of the present invention, the refrigeration system of the second or third aspect further includes a control gain correction means configured to correct the set value of the control gain calculated by the calculation means.

In the fourth aspect, the refrigeration system further includes the control gain correction means, thereby allowing for collection of a set value of the control gain by using a variable different from the target degree of superheat in the first control gain function and the average value in the second control gain function.

In a fifth aspect of the present invention, the refrigeration system of the fourth aspect, the control gain correction means includes a correction calculation means configured to calculate a correction coefficient (hereinafter referred to as a control-gain correction coefficient) for the set value of the control gain based on a first control-gain correction function in which a relationship between a control-gain correction coefficient and a deviation (hereinafter referred to as a first deviation) obtained from a target degree of superheat changed by the change means (39) and a target degree of superheat immediately before the change is determined beforehand. Here, the product of the control-gain correction coefficient and the set value of the control gain can obtain a corrected set value of the control gain.

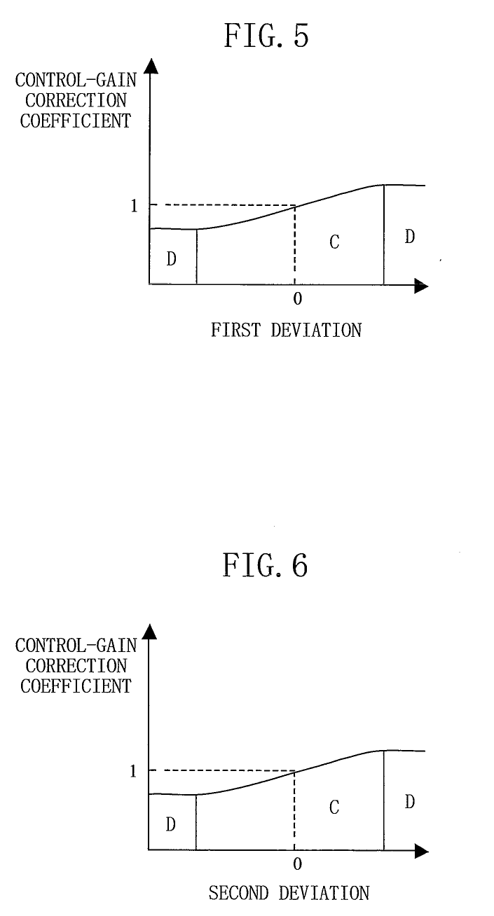

In the fifth aspect, an optimum control-gain correction coefficient can be calculated from the first deviation based on the first control-gain correction function. The first control-gain correction function herein is a function as shown in FIG. 5, for example. The first control-gain correction function includes a first region (C) where the control-gain correction coefficient changes with a change in the first deviation and a second region (D) where the control-gain correction coefficient does not change with a change in the first deviation. In the first region (C), the control-gain correction coefficient decreases as the first deviation decreases. On the other hand, the control-gain correction coefficient increases as the first deviation increases.

When the first deviation is zero, i.e., the target degree of superheat does not change, the control-gain correction coefficient is one, and the set value of the control gain does not change. When the first deviation is positive (i.e., the target degree of superheat decreases), the control-gain correction coefficient is higher than one, and the set value of the control gain is increased by correction. When the first deviation is negative (i.e., the target degree of superheat increases), the control-gain correction coefficient is lower than one, and the set value of the control gain is reduced by correction.

In a sixth aspect of the present invention, in the refrigeration system of the fourth aspect, the control gain correction means includes a correction calculation means configured to obtain a first value obtained by subtracting, from a target degree of superheat changed by the change means (39), a target degree of superheat immediately before the change, and a second value obtained by subtracting, from a measured degree of superheat calculated by the calculation means (40) immediately before the change, the target degree of superheat immediately before the change, and to calculate a correction coefficient for the set value of the control gain based on a second control-gain correction function in which a deviation obtained by subtracting the second value from the first value and a control-gain correction coefficient is determined beforehand.

In the sixth aspect, an optimum control-gain correction coefficient can be calculated from the second deviation based on the second control-gain correction function. The second control-gain correction function herein is a function as shown in FIG. 6, for example. The second control-gain correction function includes a first region (C) where the control-gain correction coefficient changes with a change in the second deviation and a second region (D) where the control-gain correction coefficient does not change with a change in the second deviation. In the first region (C), the control-gain correction coefficient decreases as the second deviation decreases. On the other hand, the control-gain correction coefficient increases as the second deviation increases.

When the second deviation is zero, i.e., a deviation between the target degree of superheat and the detected degree of superheat does not change, the control-gain correction coefficient is one, and the set value of the control gain does not change. When the second deviation is positive (i.e., the deviation between the target degree of superheat and the detected degree of superheat increases), the control-gain correction coefficient is higher than one, and the set value of the control gain is increased by correction. When the second deviation is negative (i.e., the deviation between the target degree of superheat and the detected degree of superheat decreases), the control-gain correction coefficient is lower than one, and the set value of the control gain is reduced by correction.

In a seventh aspect of the present invention, in the refrigeration system of the fourth aspect, the control gain correction means configured to obtain a first value obtained by subtracting, from a target degree of superheat changed by the change means (39), a measured degree of superheat calculated by the calculation means (40) in the change of the target degree of superheat, and a second value obtained by subtracting, from a target degree of superheat immediately before the change, a measured degree of superheat calculated by the calculation means (40) immediately before the change, and to calculate a correction coefficient for the set value of the control gain based on a third control-gain correction function in which a relationship between a deviation (hereinafter referred to as a third deviation) obtained by subtracting the second value from the first value and a control-gain correction coefficient is determined beforehand.

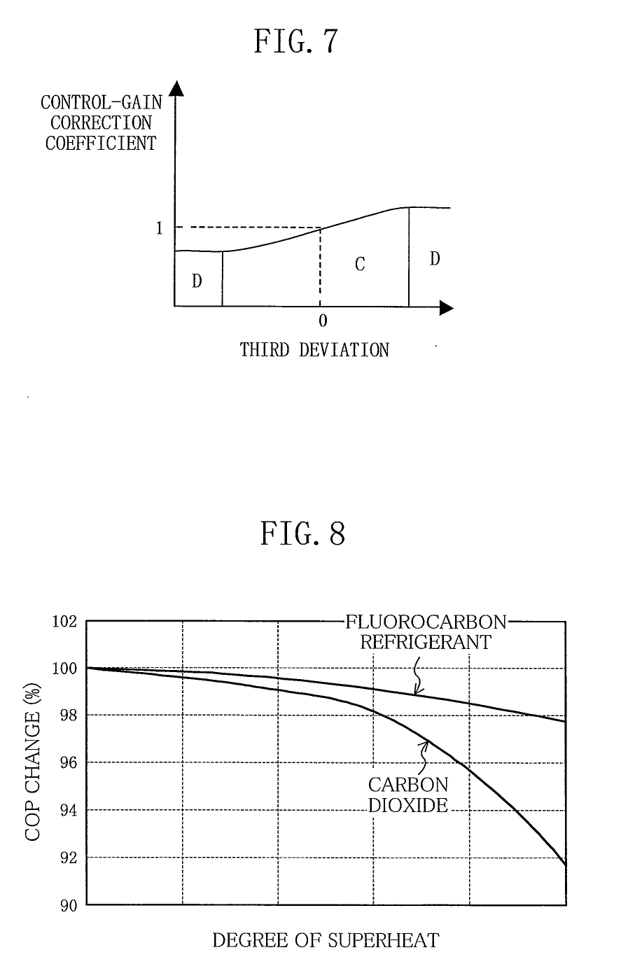

In the seventh aspect, an optimum control-gain correction coefficient can be calculated from the third deviation based on the third control-gain correction function. The third control-gain correction function herein is a function as shown in FIG. 7, for example. The third control-gain correction function includes a first region (C) where the control-gain correction coefficient changes with a change in the third deviation and a second region (D) where the control-gain correction coefficient does not change with a change in the third deviation. In the first region (C), the control-gain correction coefficient decreases as the third deviation decreases. On the other hand, the control-gain correction coefficient increases as the third deviation increases.

When the third deviation is zero, i.e., a deviation between the target degree of superheat and the detected degree of superheat does not change, the control-gain correction coefficient is one, and the set value of the control gain does not change. When the third deviation is positive (i.e., the deviation between the target degree of superheat and the detected degree of superheat increases), the control-gain correction coefficient is higher than one, and the set value of the control gain is increased by correction. When the third deviation is negative (i.e., the deviation between the target degree of superheat and the detected degree of superheat decreases), the control-gain correction coefficient is lower than one, and the set value of the control gain is reduced by correction.

In an eighth aspect of the present invention, in the refrigeration system of one of the first through sixth aspects, the refrigerant is carbon dioxide.

In the eighth aspect, the refrigeration system in which carbon dioxide is used as the refrigerant can be controlled with the degree-of-superheat control means (44).

### ADVANTAGES OF THE INVENTION

According to the present invention, responsiveness of opening-degree adjustment of the expansion valve (26) is changed according to a change in the target degree of superheat, thereby enhancing controllability of the degree of superheat. Specifically, when the target degree of superheat is reduced, the opening-degree adjustment amount of the expansion valve (26) decreases, and thus responsiveness of the detected degree of superheat to the target degree of superheat decreases, resulting in that the evaporator-outlet temperature gradually approaches the target outlet temperature. Accordingly, the evaporator-outlet temperature is less likely to overshoot the target outlet temperature. On the other hand, when the target degree of superheat is increased, the opening-degree adjustment amount of the expansion valve (26) increases, and thus responsiveness of the detected degree of superheat to the target degree of superheat increases, resulting in that the evaporator-outlet temperature approaches the target outlet temperature quickly. Accordingly, the evaporator-outlet temperature can be converged to the target outlet temperature in a short period of time.

In the second aspect, responsiveness of opening-degree adjustment of the expansion valve (26) is changed according to the optimum set amount of the control gain obtained from the target degree of superheat. This can ensure enhancement of controllability of the degree of superheat. Specifically, since responsiveness of the opening-degree adjustment decreases with a decrease in the target degree of superheat, the evaporator-outlet temperature also gradually approaches the target outlet temperature. Accordingly, the evaporator-outlet temperature is less likely to overshoot the target outlet temperature. On the other hand, since responsiveness of opening-degree adjustment of the expansion valve (26) increases with an increase in the target degree of superheat, the evaporator-outlet temperature also approaches the target outlet temperature quickly. Accordingly, the evaporator-outlet temperature can be converged to the target outlet temperature in a short period of time.

The third aspect is different from the second aspect in that responsiveness of opening-degree adjustment of the expansion valve (26) is changed based on the optimum set amount of the control gain obtained from the average value for the target degree of superheat and the detected degree of superheat. Specifically, when the detected degree of superheat is larger than the target degree of superheat, the set amount of the control gain is calculated only from the target degree of superheat, and thus the set amount of the control gain decreases rapidly in the second aspect. On the other hand, in the third aspect, the set amount of the control gain is calculated from the average value, and thus the amount of decrease in the set amount of the control gain is smaller than that in the second aspect in some cases. Accordingly, a rapid change in the set amount of the control gain can be reduced, as compared to the second aspect.

In the fourth aspect, the set value of the control gain is corrected by using a variable different from the target degree of superheat in the first control gain function and the average value in the second control gain function. Accordingly, responsiveness of opening-degree adjustment of the expansion valve (26) is changed according to the set value of the control gain from which the influence of this different valuable is eliminated. As a result, controllability of the degree of superheat can be further enhanced.

In the fifth aspect, the set value of the control gain is corrected based on the optimum control-gain correction coefficient obtained from the first deviation. Accordingly, a rapid change in the set amount of the control gain due to a rapid change in the target degree of superheat can be reduced, as compared to a case where the set value of the control gain is not corrected. As a result, controllability of the degree of superheat can be further enhanced.

In the sixth aspect, the set value of the control gain is corrected based on the optimum control-gain correction coefficient obtained from the second deviation. Accordingly, a rapid change in the set amount of the control gain due to a rapid change in the target degree of superheat can be reduced, as compared to a case where the set value of the control gain is not corrected. As a result, controllability of the degree of superheat can be further enhanced.

In the seventh aspect, the set value of the control gain is corrected based on the optimum control-gain correction coefficient obtained from the third deviation. Accordingly, a rapid change in the set amount of the control gain due to a rapid change in the target degree of superheat can be reduced, as compared to a case where the set value of the control gain is not corrected. As a result, controllability of the degree of superheat can be further enhanced.

In the eighth aspect, the refrigeration system using carbon dioxide for the refrigerant is controlled by the degree-of-superheat control means (44). Accordingly, when the target degree of superheat is reduced, the evaporator-outlet temperature is less likely to overshoot the target outlet temperature. On the other hand, when the target degree of superheat is increased, responsiveness of opening-degree adjustment of the expansion valve (26) increases, and thus the evaporator-outlet temperature can be converged to the target outlet temperature in a short period of time. On the other hand, as shown in FIG. 8, carbon dioxide described above exhibits a more considerable COP change to a change in the degree of superheat than fluorocarbon refrigerant. In view of this, the target degree of superheat needs to be set at a value smaller than that in the case of using fluorocarbon refrigerant. Accordingly, the control of degree of superheat described above can achieve stable control of the evaporator-outlet temperature even in a case where the target degree of superheat is set at a small value.

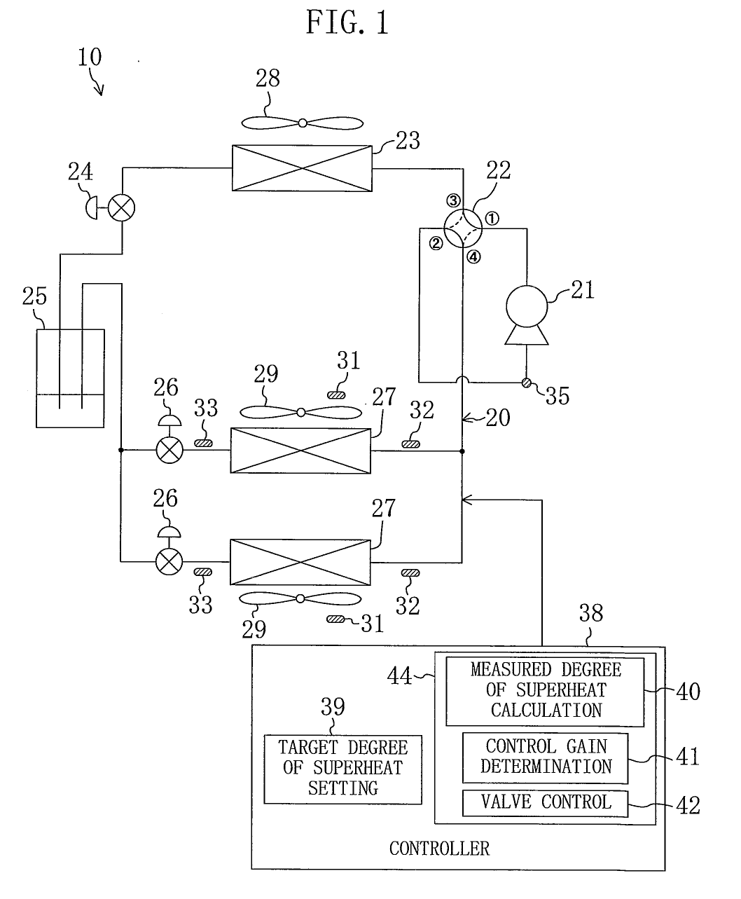

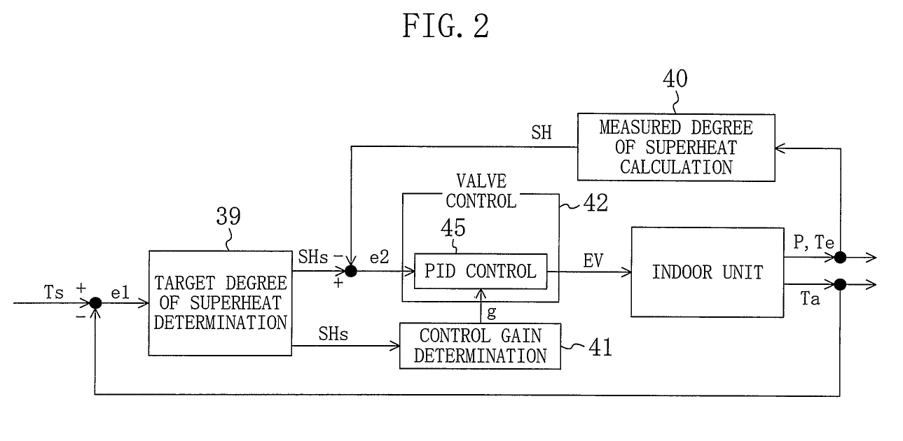

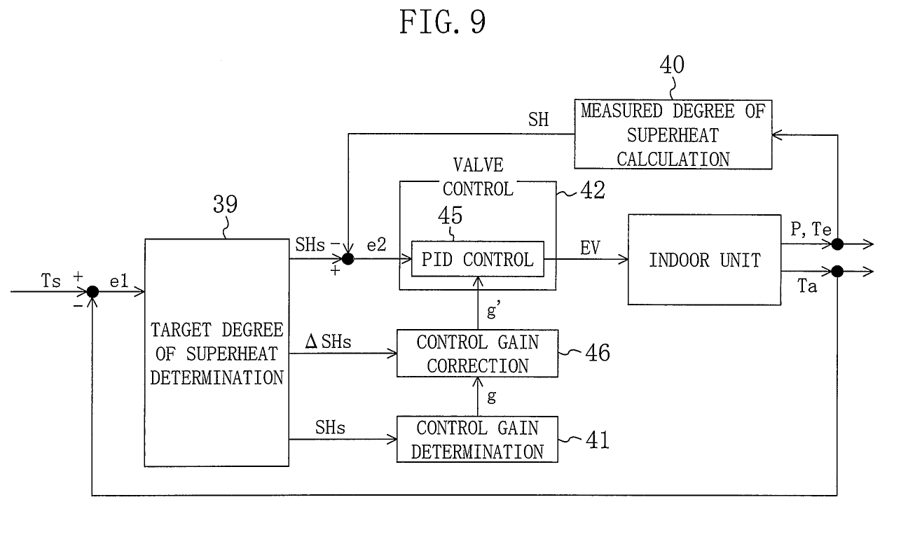

### BRIEF DESCRIPTION OF THE DRAWINGS

[FIG. 1] FIG. 1 is a refrigerant circuit diagram of an air conditioner according an embodiment of the present invention.

[FIG. 2] FIG. 2 is a control block diagram of a degree-of-superheat control unit according to the embodiment.

[FIG. 3] FIG. 3 is a graph showing a first control gain function of the embodiment.

[FIG. 4] FIG. 4 is a graph showing a second control gain function of the embodiment.

[FIG. 5] FIG. 5 is a graph showing a first control-gain correction function of the embodiment.

[FIG. 6] FIG. 6 is a graph showing a second control-gain correction function of the embodiment.

[FIG. 7] FIG. 7 is a graph showing a third control-gain correction function of the embodiment.

[FIG. 8] FIG. 8 is a graph showing a relationship between a degree of superheat and a COP.

[FIG. 9] FIG. 9 is a control block diagram of a degree-of-superheat control unit according to a modified example of the embodiment.

### DESCRIPTION OF REFERENCE CHARACTERS

10 air conditioner

20 refrigerant circuit

26 indoor expansion valve (expansion valve)

27 indoor heat exchanger (evaporator)

31 indoor temperature sensor

32 first refrigerant-temperature sensor

33 second refrigerant-temperature sensor

35 low-pressure pressure sensor

38 controller

39 target-degree-of-superheat determination unit (change means)

40 detected-degree-of-superheat calculation unit (calculation means)

41 control-gain determination unit (control-gain determination means)

42 valve control unit

44 degree-of-superheat control unit (degree-of-superheat control means)

45 PID control unit

46 control gain correction unit (control gain correction means)

### DESCRIPTION OF EMBODIMENTS

An embodiment of the present invention will be described in detail hereinafter with reference to the drawings.

As illustrated in FIG. 1, an air conditioner (10) according to this embodiment includes a refrigerant circuit (20) and a controller (38).

The refrigerant circuit (20) is a closed circuit filled with carbon dioxide as refrigerant. In the refrigerant circuit (20), refrigerant circulates so that a vapor compression refrigeration cycle is performed. In addition, the refrigerant circuit (20) is configured to perform a supercritical refrigeration cycle in which the high pressure is set to be equal to or higher than the critical pressure of carbon dioxide (i.e., a refrigeration cycle including a vapor pressure region equal to or higher than the critical temperature of carbon dioxide).

In the refrigerant circuit (20), a compressor (21), a four-way selector valve (22), an outdoor heat exchanger (23), an outdoor expansion valve (24), a receiver (25), indoor expansion valves (i.e., expansion valves) (26), and indoor heat exchangers (i.e., evaporators) (27) are connected together. In this refrigerant circuit (20), a plurality of (e.g., two in this embodiment) indoor heat exchangers (27) are connected in parallel with each other, and the indoor expansion valves (26) are respectively connected to the indoor heat exchangers (27). The compressor (21), the four-way selector valve (22), the outdoor heat exchanger (23), the outdoor expansion valve (24), and the receiver (25) are provided in an outdoor unit, whereas the indoor expansion valves (26) and the indoor heat exchangers (27) are provided in an indoor unit.

Specifically, in the refrigerant circuit (20), the compressor (21) has its discharge side connected to a first port of the four-way selector valve (22), and its suction side connected to a second port of the four-way selector valve (22). In addition, in the refrigerant circuit (20), the outdoor heat exchanger (23), the outdoor expansion valve (24), the receiver (25), and two pairs of the indoor expansion valves (26) and the indoor heat exchangers (27) are arranged in this order from a third port to a fourth port of the four-way selector valve (22).

The compressor (21) is of a variable displacement type, i.e., a so-called fully enclosed type. This compressor (21) compresses intake refrigerant (e.g., carbon dioxide) to a level equal to or higher than the critical pressure thereof, and discharges the resultant refrigerant. The outdoor heat exchanger (23) constitutes an air-heat exchanger for performing heat exchange between outdoor air taken by the outdoor fan (28) and the refrigerant. The indoor heat exchangers (27) constitute air-heat exchangers for performing heat exchange between indoor air taken by indoor fans (29) and the refrigerant. Each of the outdoor expansion valve (24) and the indoor expansion valves (26) is made of an electronic expansion valve having a variable degree of opening. Adjustment of the degree of opening of the indoor expansion valves (26) will be described later. The indoor expansion valves (26) are expansion valves according to the present invention.

The four-way selector valve (22) can switch between a first state (i.e., a state indicated by solid lines in FIG. 1) in which the first port and the third port communicate with each other and the second port and the fourth port communicate with each other, and a second state (i.e., a state indicated by broken lines in FIG. 1) in which the first port and the fourth port communicate with each other and the second port and the third port communicate with each other. Specifically, in the refrigerant circuit (20), when the four-way selector valve (22) is in the first state, refrigerant circulates in a cooling cycle, the indoor heat exchangers (27) serve as evaporators, and the outdoor heat exchanger (23) serves as a heat dissipater (i.e., a gas cooler). On the other hand, in the refrigerant circuit (20), when the four-way selector valve (22) is in the second state, the refrigerant circulates in a heating cycle, the indoor heat exchangers (27) serve as heat dissipaters (i.e., gas coolers), and the outdoor heat exchanger (23) serves as an evaporator.

The refrigerant circuit (20) includes indoor temperature sensors (31), first refrigerant-temperature sensors (32), and second refrigerant-temperature sensors (33). The indoor temperature sensors (31) are temperature detection means for detecting the temperature of indoor air taken by the indoor heat exchangers (27). The first refrigerant-temperature sensors (32) are temperature detection means for detecting the temperature of refrigerant at the outlets of the indoor heat exchangers (27) when refrigerant circulates in the cooling cycle in the refrigerant circuit (20). The second refrigerant-temperature sensors (33) are temperature detection means for detecting the temperature of refrigerant at the outlets of the indoor heat exchangers (27) when refrigerant circulates in the heating cycle in the refrigerant circuit (20). Further, a low-pressure pressure sensor (35) for detecting a low pressure of the refrigerant circuit (20) is provided.

The controller (38) includes: a target-degree-of-superheat determination unit (39) as a change means; and a degree-of-superheat control unit (44) as a degree-of-superheat control means. The degree-of-superheat control unit (44) includes: a detected-degree-of-superheat calculation unit (40) as a calculation means; a control-gain determination unit (41) as a control-gain determination means; and a valve control unit (42). The controller (38) is configured to control the degree of opening of the indoor expansion valves (26) during cooling operation.

—Operational Behavior—

Now, operational behavior of the air conditioner (10) will be described. This air conditioner (10) can switch cooling operation and heating operation.

First, in the cooling operation, the four-way selector valve (22) is set in the second state. When the compressor (21) is operated in this state, the outdoor heat exchanger (23) serves as a heat dissipater, and the indoor heat exchangers (27) serve as evaporators, thereby performing a refrigeration cycle. Specifically, supercritical refrigerant discharged from the compressor (21) flows into the outdoor heat exchanger (23), and dissipates heat into outdoor air. After the dissipation, the refrigerant passes through the outdoor expansion valve (24) and the receiver (25), then expands (i.e., is subjected to pressure reduction) while passing through the indoor expansion valves (26), and then flows into the indoor heat exchangers (27). In the indoor heat exchangers (27), the refrigerant takes heat from indoor air to evaporate, and the cooled indoor air is supplied to the room. The refrigerant which has evaporated is sucked in the compressor (21) to be compressed.

In the heating operation, the four-way selector valve (22) is set in the first state. When the compressor (21) is operated in this state, the indoor heat exchangers (27) serve as heat dissipaters, and the outdoor heat exchanger (23) serves as an evaporator, thereby performing a refrigeration cycle. Specifically, supercritical refrigerant discharged from the compressor (21) flows into the indoor heat exchangers (27), and dissipates heat into indoor air. Then, the heated indoor air is supplied to the room. The refrigerant which has dissipated heat expands (i.e., is subjected to pressure reduction) while passing through the indoor expansion valves (26). The refrigerant which has expanded passes through the receiver (25), and then further expands (i.e., is subjected to pressure reduction) while passing through the outdoor expansion valve (24). That is, refrigerant between the outdoor expansion valve (24) and the indoor expansion valves (26) including the receiver (25) is in an intermediate-pressure state. The refrigerant which has expanded in the outdoor expansion valve (24) flows into the outdoor heat exchanger (23), and takes heat from outdoor air to evaporate. The refrigerant which has evaporated is sucked in the compressor (21) to be compressed.

### <Control of Indoor Expansion Valve>

Now, control operation will be described with reference to a control block diagram of FIG. 2, in which the degree of opening of the indoor expansion valves (26) is adjusted.

First, a deviation e1 between an indoor set temperature Ts output from an indoor remote controller (not shown) and a room temperature Ta fed back from the indoor temperature sensors (31) of the indoor unit, is calculated, and is input to the target-degree-of-superheat determination unit (39). The target-degree-of-superheat determination unit (39) converts the received deviation e1 into target degrees of superheat SHs, and outputs the degrees of superheat SHs.

One of the target degrees of superheat SHs output from the target-degree-of-superheat determination unit (39) is used to calculate a deviation e2 between this target degree of superheat SHs and a detected degree of superheat SH fed back from the indoor unit via the detected-degree-of-superheat calculation unit (40), and the deviation e2 is input to a PID control unit (45) provided in the valve control unit (42). The other target degree of superheat SHs is input to the control-gain determination unit (41). Specifically, the degree-of-superheat control unit (44) is configured to adjust the degree of opening of each of the indoor expansion valves (26) based on a control gain for determining the amount of opening-degree adjustment of the indoor expansion valves (26).

The control-gain determination unit (41) converts the target degree of superheat SHs into a control gain g based on a previously stored control gain function, and outputs the control gain g. The control-gain determination unit (41) includes a calculation means for calculating a set value of the control gain g. Here, the control gain function calculated by the calculation means may be a first control gain function shown in FIG. 3 described above or a second control gain function shown in FIG. 4. The second control gain function is a function in which a relationship between the control gain and an average value for the target degree of superheat and a measured degree of superheat calculated by the detected-degree-of-superheat calculation unit (40) is determined beforehand. In the case of using the second control gain function, not only the target degree of superheat SHs but also the detected degree of superheat SH needs to be input.

For example, in a case where the control gain function is the first control gain function, as illustrated in FIG. 3, when the target-degree-of-superheat determination unit (39) reduces the target degree of superheat SHs, the control-gain deter nination unit (41) outputs a control gain g lower than the current value. On the other hand, when target-degree-of-superheat determination unit (39) increases the target degree of superheat SHs, the control-gain determination unit (41) outputs a control gain g higher than the current value.

The PID control unit (45) converts the deviation e2 into the opening-degree amount EV of the indoor expansion valves (26) in the indoor unit, and outputs the opening-degree amount EV. The opening-degree amount EV has been adjusted based on the control gain g input from the control-gain determination unit (41). At this time, when a control gain g lower than the current value is input, a ratio between the deviation e2 and the opening-degree amount EV decreases, and thus responsiveness of the detected degree of superheat SH to the target degree of superheat SHs decreases. On the other hand, the ratio between the deviation e2 and the opening-degree amount EV increases, and thus responsiveness of the detected degree of superheat SH to the target degree of superheat SHs increases.

The opening-degree amount EV output from the PID control unit (45) is input to the indoor unit, and the degree of opening of each of the indoor expansion valves (26) is changed. Then, the outlet-refrigerant temperature Te detected by the first refrigerant-temperature sensors (32), the low-pressure pressure P detected by the low-pressure pressure sensor (35), and the room temperature Ta detected by the indoor temperature sensors (31) vary. The outlet-refrigerant temperature Te and the low-pressure pressure P are converted into the detected degree of superheat SH in the detected-degree-of-superheat calculation unit (40), and is fed back in order to calculate the deviation e2. On the other hand, the room temperature Ta is fed back in order to calculate the deviation e1.

The foregoing control operation is repeated to adjust the degree of operation of each of the indoor expansion valves (26), thereby causing the detected degree of superheat SH to approach the target degree of superheat SHs.

### ADVANTAGES OF EMBODIMENT

In this embodiment, the degree-of-superheat control unit (44) can change responsiveness of opening-degree adjustment of each of the indoor expansion valves (26) according to a change in the target degree of superheat SHs. Accordingly, when the target-degree-of-superheat determination unit (39) reduces the target degree of superheat SHs, responsiveness of opening-degree adjustment of each of the indoor expansion valves (26) decreases, and thus the evaporator-outlet temperature gradually approaches the target outlet temperature. As a result, the evaporator-outlet temperature is less likely to overshoot the target outlet temperature. On the other hand, when the target degree of superheat SHs is increased, responsiveness of opening-degree adjustment of each of the indoor expansion valves (26) increases, and thus the evaporator-outlet temperature approaches the target outlet temperature quickly. As a result, the evaporator-outlet temperature can be converged to the target outlet temperature in a short period of time

### MODIFIED EXAMPLE OF EMBODIMENT

In a modified example of this embodiment, a control gain correction unit (46) as a control gain correction means is provided between the control-gain determination unit (41) and the PID control unit (45), as illustrated in FIG. 9.

The control gain correction unit (46) is configured to correct a set value of a control gain calculated by the calculation means in the control-gain determination unit (41), and includes a correction calculation means for calculating a correction coefficient for the set value of the control gain. Specifically, the control gain correction unit (46) corrects the control gain g based on a previously stored control-gain correction function, converts the control gain g into a control gain g′, and outputs the control gain g′. The control gain g′ is adjusted based on a target-degree-of-superheat deviation (a first deviation) ASHs input from the target-degree-of-superheat determination unit (39). The control-gain correction function may be a first control-gain correction function shown in FIG. 5 described above, a second control-gain correction function shown in FIG. 6, or a third control-gain correction function shown in FIG. 7. In the case of using the second or third control-gain correction function, not only the target degree of superheat SHs but also the detected degree of superheat SH needs to be input.

Specifically, in the first control-gain correction function, a relationship between a control-gain correction coefficient and a deviation (first deviation) ASHs obtained from a target degree of superheat changed by the target-degree-of-superheat determination unit (39) and a target degree of superheat immediately before the change, is determined beforehand.

In addition, in the second control-gain correction function, a first value is obtained by subtracting, from a target degree of superheat changed by the target-degree-of-superheat determination unit (39), a target degree of superheat immediately before the change, a second value is obtained by subtracting, from a measured degree of superheat calculated by the detected-degree-of-superheat calculation unit (40) immediately before the change, the target degree of superheat immediately before the change, and a relationship between a deviation obtained by subtracting the second value from the first value and a control-gain correction coefficient is determined beforehand.

In the third control-gain correction function, a first value is obtained by subtracting, from a target degree of superheat changed by the target-degree-of-superheat determination unit (39), a measured degree of superheat calculated by the detected-degree-of-superheat calculation unit (40) in the change of the target degree of superheat, a second value is obtained by subtracting, from a target degree of superheat immediately before the change, a measured degree of superheat calculated by the detected-degree-of-superheat calculation unit (40) immediately before the change, and a relationship between a deviation obtained by subtracting the second value from the first value and the control-gain correction coefficient is determined beforehand.

For example, if the control-gain correction function is the first control-gain correction function, as shown in FIG. 5, the control-gain correction coefficient decreases as the target-degree-of-superheat deviation ASHs decreases. On the other hand, as the target-degree-of-superheat deviation ASHs increases, the control-gain correction coefficient increases. Specifically, when target-degree-of-superheat determination unit (39) considerably changes the target degree of superheat SHs, the control gain g would also change rapidly in the absence of correction. However, the correction by the control gain correction unit (46) can reduce the rapid change. Accordingly, controllability of the degree-of-superheat control unit (44) can be further enhanced.

### OTHER EMBODIMENTS

The foregoing embodiment may have the following configurations.

In the above embodiment, the first control gain function and the second control gain function are used as the control gain functions. However, the present invention is not limited to this example, and other functions which allow the control gain to decrease with a decrease in the target degree of superheat, may be used.

In the above modified example of the embodiment, the first control-gain correction function, the second control-gain correction function, and the third control-gain correction function are used as the control-gain correction functions. However, the present invention is not limited to this example, and other functions which allow the control-gain correction coefficient to decrease as the detected degree of superheat approaches the target degree of superheat, may be used.

In the above embodiment, a plurality of indoor heat exchangers (27) are provided in the refrigerant circuit (20). However, the present invention is not limited to this example, and a single indoor heat exchanger (27) may be provided in the refrigerant circuit. Even in this case, controllability in the control of degree of superheat can be enhanced.

The foregoing embodiment is a merely preferred example in nature, and is not intended to limit the scope, applications, and use of the invention.

### INDUSTRIAL APPLICABILITY

As described above, the present invention is useful for a refrigeration system controlling the degree of superheat with an expansion valve.

1. A refrigeration system, comprising:
a refrigerant circuit in which at least one evaporator and at least one expansion valve associated with the evaporator are connected to each other to perform a refrigeration cycle;
a calculation means configured to calculate a degree of superheat of refrigerant based on an evaporator-outlet temperature of refrigerant circulating in the refrigerant circuit;
a degree-of-superheat control means configured to adjust a degree of opening of the expansion valve such that the calculated degree of superheat reaches a target degree of superheat; and
a change means configured to change the target degree of superheat, wherein
the degree-of-superheat control means is configured to adjust the degree of opening of the expansion valve based on a control gain for determining an opening-degree adjustment amount of the expansion valve, and includes a control gain setting means configured to increase the control gain when the change means increases the target degree of superheat and to reduce the control gain when the change means reduces the target degree of superheat.

2. The refrigeration system of claim 1, wherein the control gain setting means includes a calculation means configured to calculate a set value of the control gain based on a first control gain function in which a relationship between the target degree of superheat and the control gain is determined beforehand.

3. The refrigeration system of claim 1, wherein the control gain setting means includes a calculation means configured to calculate a set value of the control gain based on a second control gain function in which a relationship between the control gain and an average value for the target degree of superheat and a measured degree of superheat calculated by the calculation means is determined beforehand.

4. The refrigeration system of claim 2 or 3, further comprising a control gain correction means configured to correct the set value of the control gain calculated by the calculation means.

5. The refrigeration system of claim 4, wherein the control gain correction means includes a correction calculation means configured to calculate a correction coefficient for the set value of the control gain based on a first control-gain correction function in which a relationship between a control-gain correction coefficient and a deviation obtained from a target degree of superheat changed by the change means and a target degree of superheat immediately before the change is determined beforehand.

6. The refrigeration system of claim 4, wherein the control gain correction means includes a correction calculation means configured to obtain a first value obtained by subtracting, from a target degree of superheat changed by the change means, a target degree of superheat immediately before the change, and a second value obtained by subtracting, from a measured degree of superheat calculated by the calculation means immediately before the change, the target degree of superheat immediately before the change, and to calculate a correction coefficient for the set value of the control gain based on a second control-gain correction function in which a deviation obtained by subtracting the second value from the first value and a control-gain correction coefficient is determined beforehand.

7. The refrigeration system of claim 4, wherein the control gain correction means configured to obtain a first value obtained by subtracting, from a target degree of superheat changed by the change means, a measured degree of superheat calculated by the calculation means in the change of the target degree of superheat, and a second value obtained by subtracting, from a target degree of superheat immediately before the change, a measured degree of superheat calculated by the calculation means immediately before the change, and to calculate a correction coefficient for the set value of the control gain based on a third control-gain correction function in which a relationship between a deviation obtained by subtracting the second value from the first value and a control-gain correction coefficient is determined beforehand.

8. The refrigeration system of claim 1, wherein the refrigerant is carbon dioxide.
